(19) United States
(12) Patent Application Publication
(10) Pub. No.: US 2015/0261329 A1
(43) Pub. Date: Sep. 17, 2015

(54) ELECTRONIC DEVICE HAVING OPTICAL INDEXING MODULE

(71) Applicants: YUN-SHAN CHANG, SAN JOSE, CA (US); DA-WEI LIN, NEW TAIPEI CITY (TW)

(72) Inventor: YUN-SHAN CHANG, SAN JOSE, CA (US)

(73) Assignees: DA-WEI LIN, NEW TAIPEI CITY (TW); YUN-SHAN CHANG, SAN JOSE, CA (US)

(21) Appl. No.: 14/203,786

(22) Filed: Mar. 11, 2014

(51) Int. Cl. G06F 3/0354; G06F 3/042; G06F 3/038; G06F 3/03; G06F 1/16

(52) U.S. Cl. CPC G06F 3/03547; G06F 3/0308; G06F 3/0321; G06F 1/1692; G06F 1/1694; G06F 1/1615; G06F 3/0383; G06F 3/0421; G06F 2203/0332; G06F 2203/0337

(57) ABSTRACT

Disclosure herein is to an electronic device installed with an optical indexing module. The electronic device is such as a computer device. The optical indexing module is provided for controlling the cursor generated by a computer operating system. The indexing module may be disposed near the touch-control pad of a laptop computer; or cooperated with other control interfaces for controlling the cursor and performing operations. The electronic device may also be a cursor control device connected with a computer system. The cursor control device is disposed with the optical indexing module. In appearance, an opening is formed on the device for the optical indexing module allowing emitting and receiving lights there-through. The multiple sensing cells arranged in an array receive the reflected lights. An indication signal for controlling the cursor is generated by determining a moving direction according to an energy difference made among the arrayed sensing cells.

### BACKGROUND

1. Technical Field

The present disclosure relates to an electronic device having an optical indexing module, in particular, the optical indexing module of the electronic device is provided for controlling the cursor.

2. Description of Related Art

The light sensor converts the received lights into the electric signals through the sensing element such as CMOS (Complementary Metal-Oxide-Semiconductor), CCD (charge coupled device) etc. The general technology can obtain the intensity (power) of the particular lights through such elements. The light sensor can be used to determine the distance (as the distance sensor) according to the temporal energy variation, and the light sensor may be implemented as an image capturing device.

The optical indexing device may be a computer mouse. The optical indexing device can use the light sensor to determine a moving trace. When the lights are emitted to an operation plane, the light sensor can determine a moving vector according to the received energy variation. Referring to FIG. 1, FIG. 1 is a schematic view showing the internal circuit for learning the optical mouse. The optical mouse 10 moves over a surface 11. In addition to the optical elements, the optical mouse 10 includes some inner circuits within a mouse shell 12. For example, a circuit board 14 included in the optical mouse 10 has a controller 18, a light source 16, and a sensor 19. The controller 18 is adapted for controlling and computing emission and detection of lights.

The shell 12 of the optical mouse 10 has an aperture 17. The aperture 17 is toward the surface 11. The circuit board 14 is disposed near the aperture 17. The circuit board 14 has the light source 16 such as a laser or a light emitting diode (LED). When the optical mouse 10 is in operation, the light source 16 emits lights constantly, and to the surface 11 with a specific angle. The controller 18 can analyze the moving direction of the optical mouse 10 according to the signal of the reflected light or the image distribution of the reflected light intensity obtained by the sensor 19 (The sensor 19 such as CMOS or CCD).

The technology of determining the moving trace in the optical mouse 10 is depended on the signal of the reflected light via the surface 11. Accordingly, the performance of the optical mouse 10 may be affected in response to the forms of the surface 11.

The general technology may cause an issue of failing to determine the moving trace when the surface is transparent or the material not easy reflecting the lights. The issue may make relevant device unable to operate smoothly.

The way for obtaining moving trace of the lights is to utilize an additional external positioning sensor or complex calculations to make sure that the electronic device still maintains well performance in the different surface. The general technologies are only applied to the limited surfaces because of the reasons of limiting sensitivity, the high energy consumption and complex algorithms, etc. These conventional optical sensors are not applicable to adapt for all planes with highly reflectivity or low reflectivity.

### SUMMARY

The present disclosure relates to an electronic device having an optical indexing module. An exemplary embodiment of the present disclosure provides a notebook installed with the optical indexing module. The optical indexing module is provided for controlling the cursor. Another exemplary embodiment of the present disclosure provides an input device having the independent power management circuit installed with the optical indexing module. The optical indexing module provides the solutions of controlling the cursor for the different input devices.

According to the exemplary embodiment of the present disclosure, the electronic device having an optical indexing module comprises a shell installed with the optical indexing module. The optical indexing module includes a control unit, a light-emitting unit, and a light sensing unit. The control unit is adapted for integrating circuit signals within the optical indexing module. The light-emitting unit is provided as a light source to emit lights. The light sensing unit comprises a plurality of sensing cells, wherein the sensing cells are arranged in a sensing array. The sensing array is adapted for receiving lights via a light passage. The optical indexing module further includes a connection interface. The connection interface is adapted for connecting a computer system.

When the electronic device is in operation, the light source of the optical indexing module emits lights. The light source is a laser with well spatial coherence. The light source emits lights via an opening of the shell. A finger of the user can press near the opening, so that the optical indexing module receives the reflected light of the finger. The optical indexing module obtains an energy difference of a spatial interference formed around a sampling time after computing the energy received by each of sensing cells within the sampling time. The energy difference is referred to generate the moving signal for determining a moving direction.

According to another exemplary embodiment of the present disclosure, the electronic device having the optical indexing module may be cooperated with other control interface, wherein the control interface is a keypad or a touch-control pad etc. The electronic device further includes a control interface unit, and the control interface unit is connected to the control interface on the shell. The control interface unit is adapted for generating a control signal to operate the control interface.

The computer system is a computer device. The shell is a housing of the computer device. The optical indexing module is disposed within the shell, and the opening is formed on the surface of the shell. Wherein the opening is formed on top or aside of a touch-control pad of the computer device.

Further, the computer system is such as the computer device, and the optical indexing module is disposed within an input device having an independent power management circuit in accordance with one further embodiment. The shell is a housing of the input device, and the opening is formed on the surface of the shell. The input device is connected to the computer device over a wired or wireless connection.

According to the exemplary embodiment of the present disclosure, the sensing cells are arranged in the sensing array, and the sensing array is adapted for receiving lights. The sensing cells arranged in the sensing array include a plurality of dummy sensing cells. Wherein the sensor cells are disposed and spaced with a fixed distance and with even relative position there-between. The dummy sensing cells are disposed around the sensing array.

Wherein the light sensing unit further includes a plurality of comparators, and the comparators are adapted for computing the energy difference. Each of the comparators is correspondingly connected to one pair of sensing cells. Each of the comparators is adapted for comparing two energy signals, in which one of the energy signals is generated by on sensing cell. The energy signals obtained by the sensing cells render a statistical average value. Whereby the comparators compute the energy differences with the spatial interference formed around the sampling time.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic view showing the internal circuit of learning the optical mouse.

FIG. 2 is a schematic view showing the incidence plane and the light path for reflected light.

FIG. 3 is a schematic view showing the sensing array for installing a semiconductor circuit within of the instant disclosure.

FIG. 4A is a schematic view showing the electronic device having the optical indexing module for the first embodiment of the instant disclosure.

FIG. 4B is a schematic view showing the electronic device having the optical indexing module for the second embodiment of the instant disclosure.

FIG. 5 is a schematic view showing the electronic device having the optical indexing module for the third embodiment of the instant disclosure.

FIG. 6A is a schematic view showing the electronic device having the optical indexing module for the fourth embodiment of the instant disclosure.

FIG. 6B is a schematic view showing the electronic device having the optical indexing module for the fifth embodiment of the instant disclosure.

FIG. 7 is a schematic view showing the optical indexing module of the electronic device for the embodiment of the instant disclosure.

FIG. 8 is a circuit block view showing the optical indexing module of the electronic device for the embodiment of the instant disclosure.

FIG. 9 is a schematic view showing the sensing array for the embodiment of the instant disclosure.

FIG. 10 is a schematic view showing the layout of the sensing cells for the sensing array of the instant disclosure.

FIG. 11 is a diagram showing each of the sensing cells to perform the moving trace method for the sensing array of the instant disclosure.

FIG. 12 is a diagram showing each of the sensing cells to perform the moving trace method for the sensing array of the instant disclosure.

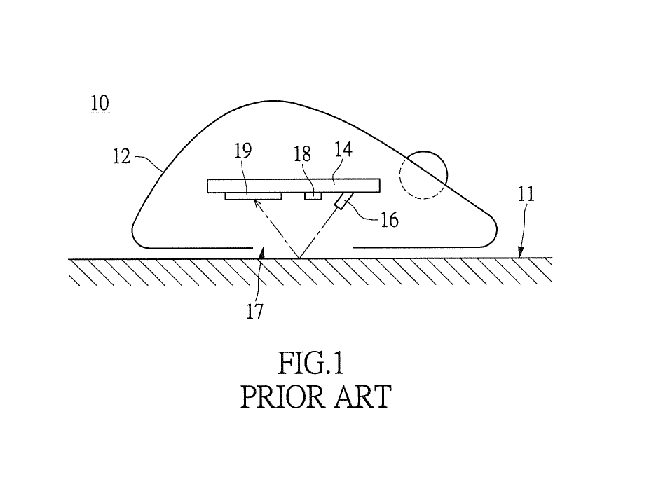

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

The present disclosure relates to an electronic device having an optical indexing module. The optical indexing module includes a plurality of sensing cells arranged in a sensing array. The sensing array is formed in a light sensing unit. The light sensing unit is the circuit which receives external light signals and converts the signals into information of a moving direction. In an exemplary embodiment of the present disclosure, a light-emitting unit used to generate lights is described. The light sensing unit receives the reflective lights from an external object surface. The electronic device then determines the constructive or destructive interference ipattern of the reflective lights based on the energies calculated from the sensing cells. Thus, the electronic device determines a moving direction according to the energy difference.

The light source can emit coherent light or the lights with well spatial coherence. Thereby the way to determine the moving direction can be operated with a scheme of sensitivity compensation. The related light movement recognition algorithm can simultaneously reduce the noise. Accordingly, the device using the algorithm can be applied to any planes.

An exemplary embodiment of the present disclosure relates to the optical indexing module within the electronic device which adopts a coherent light source package integration technology. The device using the technology needs not to install any extra optical lens or particular image sensor, such as CMOS image sensor (CIS). The device needs not to install any optical elements (such as lens, reflective lens etc.) along the light path. The device can immediately receive the reflective lights by using the sensing cells. The device calculates the energy changes around a period of time. The device is therefore configured to detect any operation and to control the cursor.

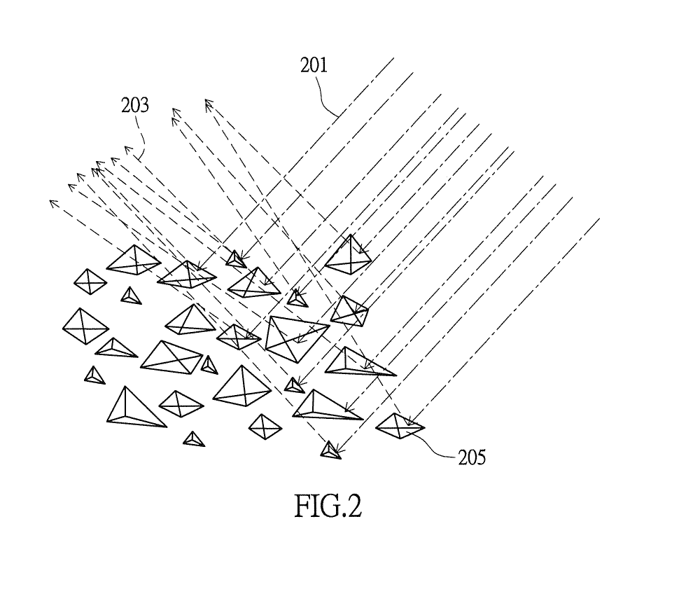

First of all, FIG. 2 is a schematic view showing the incidence plane and the light path for reflected light. A particular light source device generates the incident lights 201 to emit a plane. When the plan reflects the incident lights 201, a plurality of reflective light paths are formed. The light source particularly utilizes a coherent light such as laser. The coherent light means the light having well spatial coherence.

The view shows a plurality of light paths. The light paths include the incident lights 201 emitted to a surface structure 205 of the plane. The incident lights 201 then become the reflective lights 203. Because the surface structure 205 is irregular, the reflective lights form the different directions.

The light source device constantly generates the incident lights 201 reach the plane. Reflective lights 203 are formed via the plane. The sensor constantly receives the reflective lights 203 in the process. A variety of the light paths generate constructive and destructive interference pattern. Accordingly, the coherent light is particularly adopted as the incident lights 201 in order to improve the interference effect.

When the device having the circuit determines the moving trace moves over the operation plane (X-Y plane), the sensor receives the reflective lights 203 and computes the energy difference made at different time or different locations according to the data sampled around a time slot. Then the average energy value is also computed. The present disclosure provides the optical indexing module using the sensor array to determine the moving trace according to the energy difference when the sensor array obtains the energy at the different locations. The average value is computed by acquiring the energies obtained by all or part of the sensing cells. For example, the average of the row or the column is the reference value to make the compuration. Alternatively, the average energy value may be made by referring to the peripheral or the middle portion of cells.

According to the exemplary embodiment, it will enhance the interference effect of the reflective light if the light source is the coherent light. The coherent light has a very small phase delay in a wave envelope. The laser is one choice of the sources with the coherent light rather than the sunlight or LED.

The present disclosure relates to the optical indexing module using the coherent light. The coherent light can improve the sensitivity of the light sensor of sensing the reflected light. Because the coherent light has the characteristics of the small phase difference. The spatial interference generated by the coherent light relative to the incoherent light has the smaller phase delay. Accordingly, using the coherent light can enhance the advantage of the spatial interference. The sensing array can obtain a difference of the spatial interference via the reflective lights.

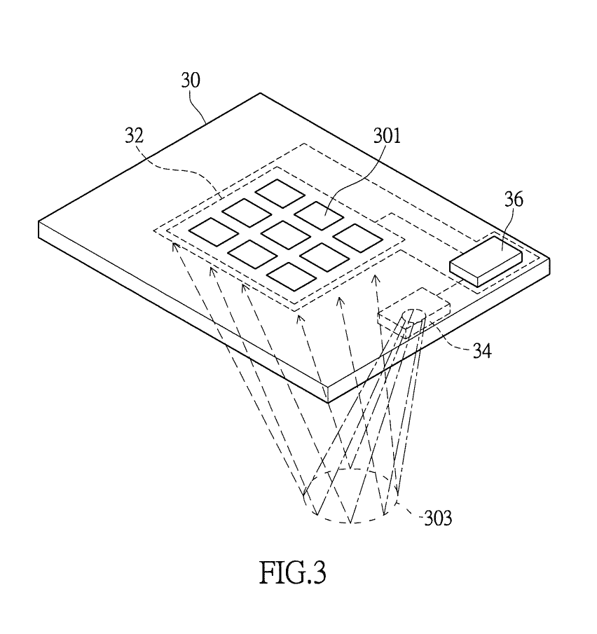

Refer to FIG. 3, which is a schematic view showing the sensing array for installing a semiconductor circuit within of the instant disclosure. According to the exemplary embodiment of the present disclosure, the sensing array and the controller circuit can be integrated into a semiconductor circuit. The light source, the sensing array, and the controller can be installed into a circuit board of the optical indexing module. Accordingly, the present disclosure does not need to use the optical collection device for improving the light sensitivity. The optical collection device is the particular optical lens or particular semiconductor processing (such as CIS).

The optical indexing module of the present disclosure is installed in the electronic device or a particular indexing device such as the example shown in FIG. 3. The sensing array 32 includes a plurality of sensing cells 301 arranged in the sensing array 32. The sensing array 32 and the controller 36 of the circuit integrated are integrated into an IC through this technology of integrated package in the exemplary embodiment. The sensing cells 301 of the sensing array 32 are disposed apart with a fixed distance and overall with an average relative position there-between. The sensing cells 301 uniformly receive the reflected light from the particular operation plane. FIG. 3 illustrates a light source 34 emitting lights to an irradiation range 303. Then the plane reflects the lights into the sensing array 32. Wherein each of the sensing cells 301 receives the reflected light with different directions respectively. The controller 36 and the related circuit of the device can compute the average value of sum energy received by each of the sensing cells 301 via appropriate optical signal conversion. Then the controller 36 and the related circuit of the device compute the difference between each of the sensing cells 301 and the average value. The controller 36 and the related circuit can obtain an energy difference of the spatial interference formed the plane or the reflective. The controller 36 determines the moving direction according to the energy difference formed around a sampling time slot.

The spatial interference means a light interference. Because of the lights are emitted to the plane with the irregular surface structure, and the lights are formed the reflective lights with different directions. The lights generate constructiveness and destructiveness interference pattern after reflecting. Thereafter, the sensing array obtains the spatial information of the reflecting because the device moves over the plane. Then the sensing array creates the moving data of X-Y plane.

Specifically, the carrier of the light sensing array device is like the electronic device having the light source using the laser of the optical indexing module. Wherein the major circuit elements includes the light source 34, the sensing array 32, and the controller 36. The light source 34 is disposed on a circuit board 30, and the light source 34 is adapted for generating an incident lights. The sensing array 32 includes a plurality of sensing cells 301 arranged in the sensing array 32. The controller 36 is connected to the light source 34 and the sensing array 32. The controller 36 obtains the light signal received by the sensing pixels of the sensing cells and calculates the energy state. The controller 36 is adapted for calculating the energy state difference around the sampling time.

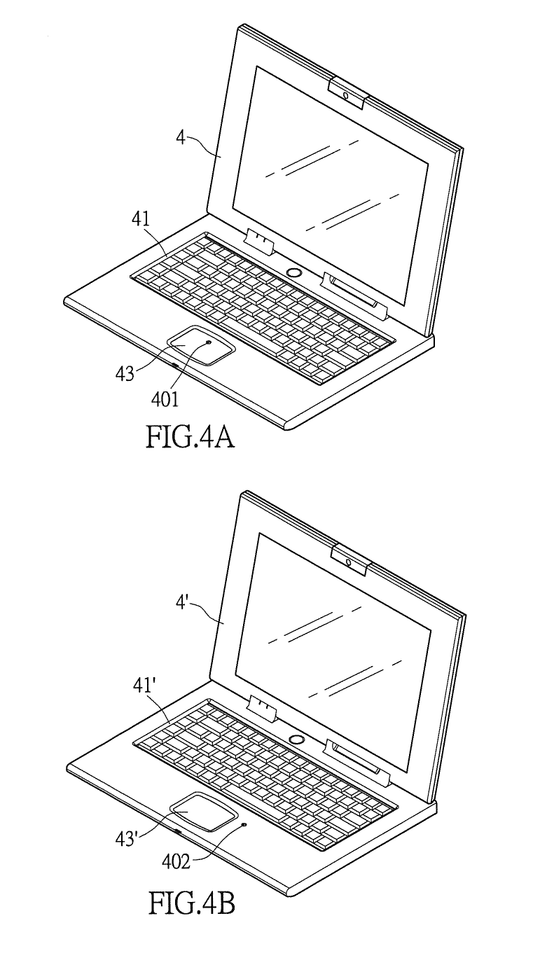

FIG. 4A is a schematic view showing the electronic device having the optical indexing module for the first embodiment of the instant disclosure. The optical indexing module of the exemplary embodiment is applied to a laptop computer 4.

The laptop computer 4 has a keyboard 41 and a touch-control pad 43 etc. The optical indexing module is disposed within the touch-control pad 43. And an opening 401 is formed on top of the touch-control pad 43. In practice, the finger of the user can be pressed on the opening 401. The finger can effectively control the cursor by a small range of movement. Wherein each Dot-Per-Inch (DIP) may be adjusted according to the user need. The optical indexing module can be operated with the touch-control functions or the original operating functions of the touch-control pad 43, such as left and right button functions.

Because the laptop computer 4 still maintains the original operating functions of the touch-control pad 43. The optical indexing module may be enabled or disabled according to the operational requirement.

Next, FIG. 4B is a schematic view showing the opening 402 of the optical indexing module forming aside of the touch-control pad 43 of the laptop computer 4. It is noted that the volume of the optical indexing module is not big. Accordingly, the opening 402 may be adjusted according to the design of the device.

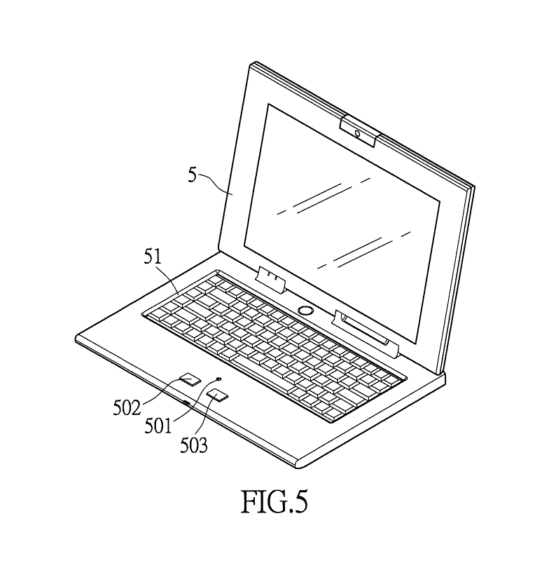

FIG. 5 is a schematic view showing the electronic device having the optical indexing module for another embodiment of the instant disclosure. The electronic device of the exemplary embodiment is a laptop computer 5 which has common keyboard 51. The optical indexing module is disposed aside of the keyboard 51 near the user. The user can easily use the fingers to operate the optical indexing module. An opening 501 is formed on the shell of the laptop computer 5. The optical indexing module emits lights via the opening 501. And the optical indexing module receives the reflective lights via the opening 501, such as the reflective lights reflected by the finger skin.

In addition to the optical indexing module, the laptop computer 5 also has the control interfaces 502, 503 which like the mouse buttons. When the laptop computer 5 is in operation, the finger of the user can be pressed on the opening 501. The finger is adapted for controlling the cursor of the laptop computer 5, and then the finger further controls the control interfaces 502, 503. In practice, the numbers and positions of the control interfaces, and the function of the control interfaces may be adjusted according to the actual demand.

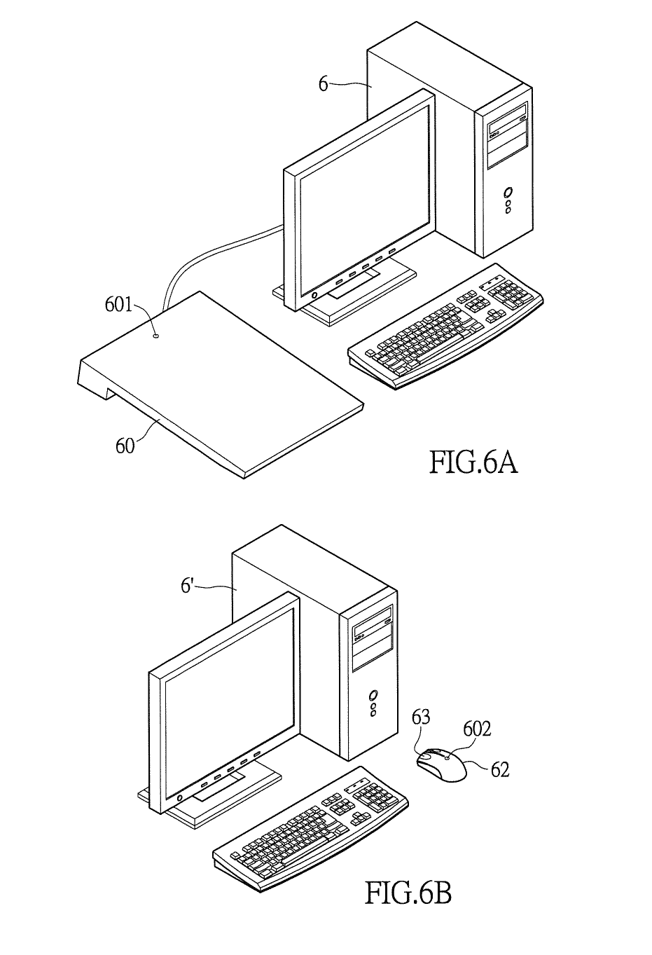

In addition to the laptop computer of the exemplary embodiment, the electronic device also is an input device having an independent power management circuit. The electronic device combines the optical indexing module with traditional keyboard which disposed on the mouse or operate independently touch-control pad. Referring to FIG. 6A, FIG. 6A is a schematic view showing the embodiment of the instant disclosure.

In the exemplary embodiment, a touch-control pad 60 is an input device having an independent power management circuit. The internal battery or a computer device 6 provides the electric power for the input device. If the touch-control pad 60 connects to the computer device 6 over a wireless connection. The touch-control pad 60 has an independent power supply. The touch-control pad 60 is one of the input measures for the computer device 6, such as controlling the cursor of the operating system. In another exemplary embodiment, the touch-control pad 60 also can connect to the computer device 6 over a wired connection.

In the exemplary embodiment, the optical indexing module of the present disclosure is disposed within the touch-control pad 60. An opening 601 is formed on the surface of the touch-control pad 60. The optical indexing module emits lights via the opening 601. And the optical indexing module receives the reflective lights which are reflected by the finger skin of the user. The optical indexing module can determine the moving direction of the finger over the opening 601 according to the energy changes which are obtained by the sensing mechanism around a time.

A similar design can be used on the electronic device shown in FIG. 6B. An electronic device 62 is similar with the mouse illustrated in the exemplary embodiment. The electronic device 62 is also an input device having an independent power management circuit. The optical indexing module of the present disclosure is disposed within the electronic device 62. An opening 602 is also formed on the surface of the electronic device 62 to emit and receive lights there-through, further includes the other one or multi-functional key 63. It can base on the actual situation to change design.

In other words, when the user controls the electronic device 62 of the exemplary embodiment, do not have to move as the traditional way of operating a computer mouse, but hand the electronic device 62, fingers can press over the opening 602, it can achieve the purpose of the general operation of the cursor by a smaller range of movement. Key 63 is to perform certain actions, such as left and right of mouse buttons.

The electronic device 62 can connect to a computer device 6′ over a wired or wireless connection. The electronic device 62 connected the moving signal sensed by the optical indexing module and control signal generated by Key 63, after generating commands of control cursor and transfer to the computer device 6′.

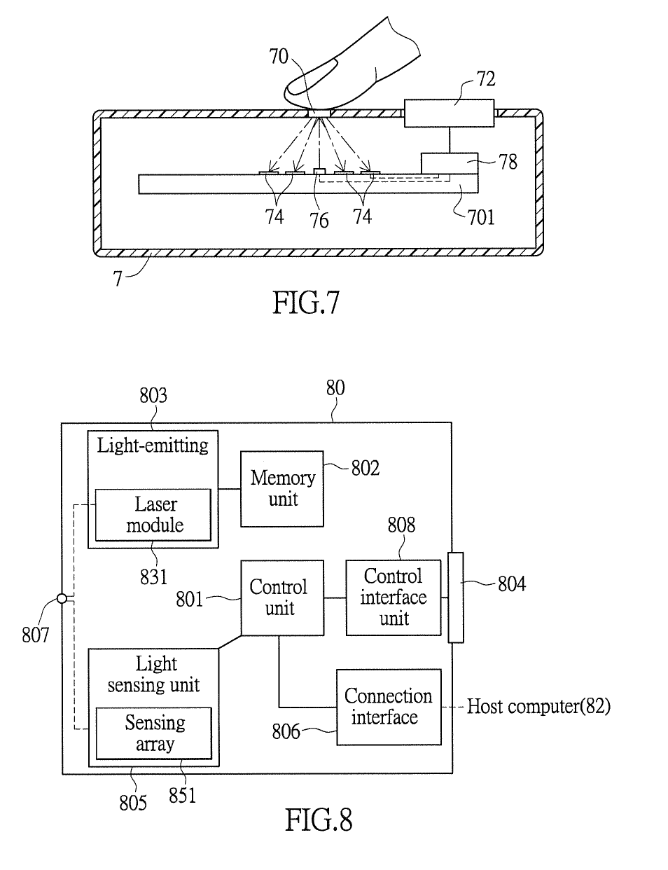

The optical indexing module in the electronic device of the exemplary embodiment of the present disclosure can found in diagram of FIG. 7.

Application of the optical indexing module achieved the electronic device of the present disclosure can found in schematic diagram of the circuit design of FIG. 7. The diagram shows the coated electronic device 7 by a shell, according to variety the embodiment as above, such as laptop computer or any needs to control the cursor moving electronic devices, such as tablet PC, an input device having an independent power management circuit, such as touch-control pad, mouse and so on. There has a circuit board 701 in the electronic device 7, which contains the necessary operation of the circuit element. The view shows that there is an opening on the shell of electronic device 7 (the opening means a light channel 70), the opening is located at internal corresponding light source (Light-emitting unit 76) for Light beam emitting electronic device 7, and then receives the reflected light through the opening, so that the reflected light by a plurality of the sensing cells of array arrangement to receive. The opening 70 is the light channel as described. The electronic device 7 injected via light channel 70, and received the external objects' reflection by the light channel 70.

Depending on the operating situation of this example, users slide with hands directly on the opening of the electronic device 7, rather than use the traditional way by holding the mouse to move with hands. Because the skin of fingers must have a rough surface, the present disclosure uses the energy changes of the interference phenomenon of the reflective light around the time to determine the moving direction of the finger, namely the external object.

There is a necessary circuit cell for operational on the circuit board 701 inside the electronic device 7, such as control unit 78. The control unit 78 connected the other units, such as light-emitting unit 76, the light-emitting unit 76 is set correspond to light passage 70 for the purpose of light beam emitting, the light-emitting unit 76 has a better light source such as laser that with coherence. The control unit 78 can dynamically control the light energy from the light-emitting unit 76, based on feedback of the received energy from sensing cells and adjust the luminous energy or/and through the adjustment of pulse width modulation to control the cycle of light-emitting unit 76.

In the exemplary embodiment, the light source of light-emitting unit 76 can set in the center or near of multiple sensing cells in array, so that the reflected light can be more evenly sensed by the multiple sensing cells. The location of light passage 70 and light source is designed for vertical incident reflection and coherent light.

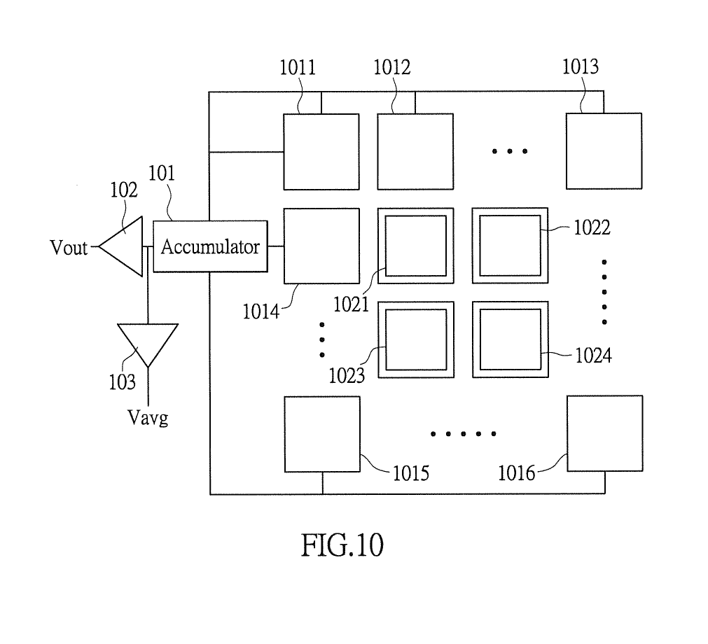

In diagram, there has sensing array 74 consist of multiple sensing cells in array setting on the circuit board 701, and the electrical property is connected to the control unit 78, sensing cells' location can refer to FIG. 10. Multiple sensing cells include multiple dummy sensing cell, which is better setting in around of dummy sensing cell, The received energy may not be the reference of the movement direction, but can be used to the reference of the energy output adjustment. The control unit 78 can dynamically adjust the light energy by the light-emitting unit 76, according to the light energy from the multiple dummy sensing cells to adjust the drive current of the light-emitting unit 76 as mentioned before.

In the exemplary embodiment, the energy changes because of the interference as mentioned above to determine the movement direction of finger or external objects, the control interface of software or hardware can set on outside of device 7. In the exemplary embodiment, the diagram shows one or more Key 72 near of hands, key 72 do not limit in the form of hardware, software also can show the key 72 on a plane. Associated circuitry of Key 72 connected to the control unit 78, the exemplary embodiment is a function key of light pointing device such as left and right buttons of the computer mouse.

Next, FIG. 8 is a circuit block view showing the optical indexing module of the electronic device for the exemplary embodiment of the instant disclosure.

The figure shows the core of the main circuit unit of the electronic device 80. In which, a control unit 801 is provided to process in and out signal of circuit unit. The present disclosure relates to the control unit 801 means the necessary circuit for control device operation, numerical computation, judgment, etc. The control unit 801 is responsible for obtaining the generated signal from each circuit unit and performs the necessary operations; the performance can by the control unit 801 itself or a specific micro-processing circuitry.

The main circuit of the electrical property connected to control unit 801 is described as follows. Please refer to the figure, a memory unit 802, a light-emitting unit 803 (including laser module 831), a light sensing unit 805 (including sensing array 851), a control interface unit 804 connected to control interface unit 808, and a computer system 82 connected to connection interface 808, etc. are included. The exemplary embodiment shows the disposal of the circuits can be increased, decreased, or merged based on the practical needs.

As shown in the schematic view, an opening 807 is formed on the shell of the electronic device 80. It is unlike the general optical indexing module which needs to install lens and/or reflective lens. The opening 807 is only a mechanics allowing the lights emitted to the external object. The opening 807 has a transparent protective lens as a protective means. The opening 807 is disposed at a location opposite to the light source of the light-emitting unit 803. The opening 807 facilitates the lights emitted out of the electronic device 80. The multiple sensing cells arranged in the array are used to receive the reflected light via the opening 807.

Memory unit 802 is a memory of the electronic device 80 for temporarily storing the signals. Memory unit 802 includes necessary firmware or software for storing operation. The light-emitting unit 803 includes laser module 831 or specific light source. The light-emitting unit 803 is controlled by the control unit 801. The control unit 801 can dynamically adjust the emitting energy based on the feedback information from the light sensing unit 805.

As show in FIG. 3, 9, 10 of the present disclosure, the light sensing unit 805 includes the sensing array 851. The light sensing unit 805 mainly includes a plurality of sensing cells arranged in the array. The sensing cells can receive the reflective lights at the same time and compute the energy information. Whereby the sensing cells determines the moving direction according to energy changes.

The electronic device 80 of one embodiment is connected to an external host computer which has an independent power management circuit. The connection as shown in the FIG. 8, the connection interface 806 is connected to a computer system 82. The computer system 82 is a computer device over a wired (such as USB) or wireless (such as Radio, Wireless Networking, Bluetooth communication, etc) connection. The computer system 82 also can be a module built-in a computer device. The connection interface 806 is connected to the computer system 82 over internal circuit connection. The electronic device 80 can install an internal power supply, such as a battery, meanwhile the electronic device 80 may take power by the computer system 82, such as via USB. Wherein the electronic device 80 has a power management circuit. According to the exemplary embodiment, in addition to using the optical indexing module to obtain moving signal, the electronic device 80 also collocate with some traditional control interface 804, such as buttons, touch-control pad, roller and other cursor control device. The electronic device 80 has a control interface unit 808 which obtains these control signals. The control interface unit 808 is connected to the control unit 801. The obtained control signals (such as touch signals, key signals) by the control unit 801 with the moving signal generating a command sent to the computer system 82. In particular, the command is used to control cursor movement.

The electronic device 80 can send the moving signal which is obtained by the optical indexing module to the computer system 82 via the connection interface 806. The electronic device 80 also sends the controlling signal which is generated by the control interface unit 808 to the computer system 82. The computer system 82 generates the command for controlling the operation of the cursor.

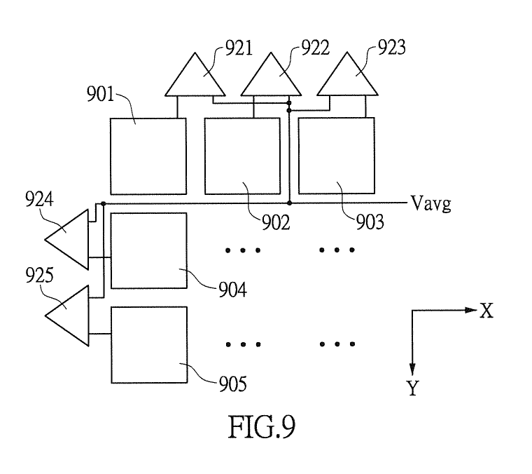

The operation of the sensing cells in the optical indexing module is referred to FIG. 9, which is a schematic view showing energy pattern for the exemplary embodiment of the instant disclosure.

FIG. 9 shows the layout of the sensing array. A plurality of sensing cells located in the X-Y plane is formed as an NxM sensor array. The sensing array may be, but not limited to, in form of symmetrical rectangular, square, round, oval, or any geometrical shapes. The sensing array includes a plurality of sensing cells 901, 902, 903, 904, 905 arranged in an array. The sensing cells are disposed along the direction of X, Y respectively. The actual number of the sensing cells is not limited to the schematic. The circuit board which disposed the sensing cells 901, 902, 903, 904, 905 also has a plurality of comparators 921, 922, 923, 924, 925. Each of the comparators is correspondingly connected to one sensing cell. The input is an average voltage signal Vavg generated by each of the sensing cells. The average voltage signal Vavg is adapted for comparing with the voltage signal which generated by the sensing cells after sensing the lights. The result of comparison is a signal value of high and low voltage. Finally, the control circuit obtains the result of comparison in the two adjacent sensors and determines the moving direction.

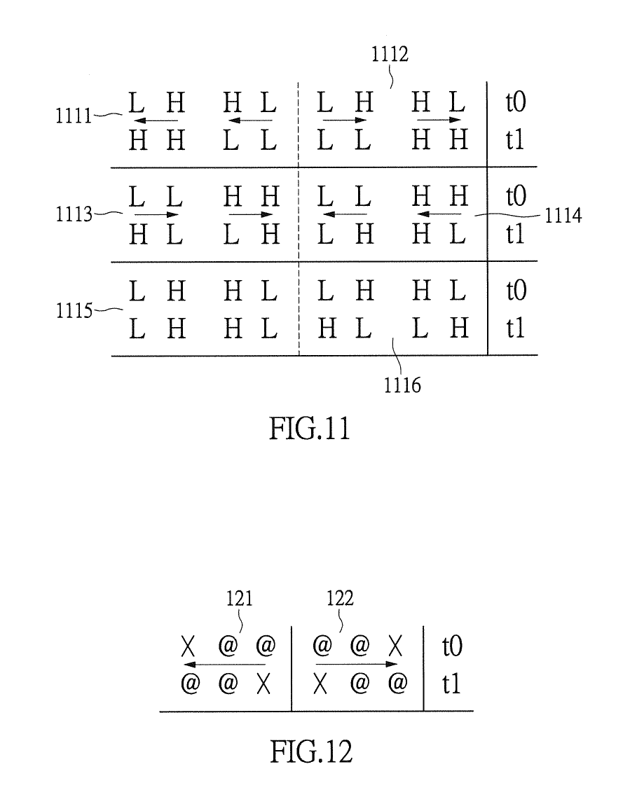

The comparator 921 is connected to the sensing cell 901, wherein one of the input signals is generated by the sensing cell 901. The input signal can express voltage signal. The other one of the input signals is an average voltage signal Vavg. The comparator 921 is used to compare the two input signals and output a result of comparison. The present disclosure directs the result of comparison to express by a binary characteristic value. Such as shown in FIG. 11 H and L is represented high and low voltage signal respectively.

According to the sensing array of the present disclosure, the light formed constructiveness and destructiveness interference pattern through the plane reflected for displaying the energy pattern by using the tracing way of the sensing array. It determines the moving direction by analyzing the changes of the energy distribution at different times. For example the exemplary embodiment can use a non-relative view points to do movement judgment. This is introduced into the energy information around the sensing cells and the average of the energy for comparison to determine the moving direction. It is worth mentioning that this differs from the general way for using the information of image pixel to determine the moving direction. The present disclosure is calculating the energy changes and using the time to determine the moving direction. And the energy changes may use a binary characteristic values (such as H and L), the binary characteristic values is a contrast between the value of the sensing cells and the average value.

According to one of the exemplary embodiment, the present disclosure is used of the sensor chip layout of the sensing array device which installed with the electronic device. The sensor chip includes a plurality of sensing cells arranged in a sensing array. The sensing cells include a plurality of inoperative sensing cells around the sensing array (hereinafter referred to as “dummy sensing cells”) and a plurality of working sensing cells located within the centre for receiving light. Therefore, the control circuit of the device and the correlation computing circuit only obtain the energy signals of non-dummy sensing cells and continue to use the energy signals. Accordingly, the dummy sensing cells do not provide the energy signals to determine the moving direction. The dummy sensing cells can be a function of determining the optical signal. Refer to FIG. 10, which is a schematic view showing the layout of the sensing cells.

The view showing a sensor chip has a plurality of sensing cells arranged in a sensing array. The dummy sensor is disposed around the sensing cells located within the centre of the embodiment. The purpose is to make the process of the sensor chip more uniform, thus making more uniform can be sensed energy. The exemplary embodiment showing the dummy sensing cells 1011, 1012, 1013, 1014, 1015, 1016 are the inoperative sensing cells. The sensing cells 1021, 1022, 1023, 1024 located within the centre are main sensing cells for sensing light energy.

When the sensing cells arranged in a sensing array at the same time exposure to the reflective lights. Wherein the sensing cells more toward the centre can uniformly sense the lights. And sensing cells around the sensing array may have received energy be uneven. Accordingly, by setting up the dummy sensing cells (1011, 1012, 1013, 1014, 1015, 1016) to exclude the energy values may cause unstable signals, and can obtain the reference energy values with the reference worth.

As shown in FIG. 10, the circuit has an accumulator 101 which is connected to the each sensing cells of the sensor chip. The accumulator 101 can obtain the optical signals of the each sensing cells, and the accumulator 101 can convert the optical signals into a voltage value through an analog-to-digital conversion. However, the voltage value is converted into a valid reference value through the gain amplification stage because of the optical signals are very small. The circuit computes the energy difference around the sampling time. According to the exemplary embodiment, the optical signals are processed by the gain of the amplifier 102 to form an output signal, such as output voltage Vout. In addition, the optical signals are processed by a calculator 103 to obtain a average value of the output voltage, such as average voltage signal Vavg

Next, the output signal (such as output voltage Vout) and average value (such as average voltage signal Vavg) input to the comparator of FIG. 9. The comparator is adapted for comparing the energy signal of the sensing cells with a reference value (such as a statistical average value of the effective energy obtained by the sensing cells), whereby obtaining the energy state of the sensing cells. Each sensing cells can be digitally high (H) and low (L) to represent the energy state in practice.

The circuit of the optical indexing module drives the light source to emit lights. The reflected lights from a surface enter the device via the same opening. The sensing array is adapted for receiving the reflected lights. In particular, the multiple sensing cells arranged in the array are in order to receive the reflected lights. Next, the optical indexing module computes he energy received by each of sensing cells within a sampling time. Using the above-method obtains the energy difference of the spatial interference formed around the sampling time. The energy difference is referred to generate the moving signal for determining a moving direction.

The control unit can dynamic adjust the light energy of the light-emitting unit according to the information of the energy calculation in the process. Such as by adjusting the driving current of the light-emitting unit control the output energy. The control unit also can control the exposure time of the light sensing unit for receiving the incident lights and output the gain of the output energy signal. The control unit computes the energy received by each of sensing cells within a sampling time. The sensor array can be adapted to many cases of the surface according to the compensating mechanism which established by adjusting the light intensity/brightness and the exposure time, such as different surface structures and the distance to the surface.

Next, refer to FIG. 11 and FIG. 12, FIG. 11 and FIG. 12 are showing the method of the determining the moving direction according to the energy difference which received by each of sensing cells around a time. The main method is using the comparators which correspondingly connected to each sensing cells to compare the received energy signal with a statistical value of the energy signal. The comparators compute the energy difference of the spatial interference formed around the sampling time.

Using two bit capture image to execute the determination of the moving direction can refer to FIG. 11. FIG. 11 is a diagram showing the sensing cells to perform the moving trace method for the sensing array of the instant disclosure.

The exemplary embodiment is showing a plurality of sensing cell combinations 1111, 1112, 1113, 1114, 115, and 1116 which are arranged in many sensing arrays. This exemplary embodiment is only illustrative determining the moving direction according to the energy difference which is sensed by the adjacent sensing cells at different times (such as the first time t0, the second time t1).

Wherein t0 and t1 are around a sampling time, H and L are respectively represented high and low voltage signals which are outputted by the comparators. In other words, it can be considered the energy state. It is mainly determining the whole moving vector according to the voltage signal changes around the time. FIG. 11 is a diagram showing the energy difference of each sensing cells around the time.

For example, the sensing cell combination 1111 has at least two sensing cells. Wherein the left energy states mean that the L and H energy states are sensed by the two sensing cells at the first time t0. When at the second time t1, the energy states of the two sensing cells are converted into the H and H energy states. When L, H (t0) are converted into H, H (t1), the energy state of the sensing cell changes from L to H. It means that the left side L is replaced by right side H. Accordingly, it can initial determine the moving direction around the sampling time is left.

While another group of sensing cells of the sensing cell combination 1111 at the first time t0, the energy states of the sensing cells are the H and L energy states. When at the second time t1, the energy states are converted into the L and L energy states. Wherein one of the energy states is converted the H energy state into the L energy state. It means that the left side H is replaced by right side L. Accordingly, it can initial determine the moving direction around the sampling time is left.

For another example, the left sensing cells of the sensing cell combination 1112 at the first time t0, the energy states of the sensing cells are the L and H energy states. When at the second time t1, the energy states are converted into the L and L energy states. It means that the right side H is replaced by left side L. Accordingly, it can initial determine the moving direction around the sampling time is right.

Similarly, the right sensing cells of the sensing cell combination 1112 at the first time t0, the energy states of the sensing cells are the H and L energy states. When at the second time t1, the energy states are converted into the H and H energy states. It means that the right side L is replaced by left side H. Accordingly, it can initial determine the moving direction around the sampling time is right.

The sensing cell combinations 1115 and 1116 in FIG. 11 do not have the direction of the arrow. Because of the energy states of the sensing cells do not change around the sampling time, or the moving direction could not be determined according to the energy states. For example, the energy states of the sensing cell combination 1116 are the L and H energy states at the second time t1. When at the second time t1, the energy states are converted into the H and L energy states. Accordingly, it can't determine the moving direction accord to the energy states.

When the all sensing cells are provided to determine the moving direction around the sampling time, the electronic device can determine an overall movement direction.

The shown aspect for recognizing the moving vector is based on the transformation of the energy states of the sensor pixels at different times. The label “X” indicates meaningless value; and label “@” shows the available sensing signal be found between the times t0 and t1. The aspect utilizes the change among the labels to determine the moving vector.

The signal energies received by the multiple sensor pixels in the sensor chip can be compared with an average at the different times while the sensor chip receives the reflected light. The comparison results in high or low voltage signal. For example, the label “@” shown in the diagram represents the available voltage signal. In some conditions, it is labeled as “X” when no energy change or no meaningful voltage signal fluctuation can be found.

In the embodiment shown in FIG. 12, in the sensor pixel group 121, the label “X@@” shows the comparator found the energy change among the adjacent sensor pixels at the first time t0. At the second time t1, the energy change made to the sensor pixels are labeled as “@@X”. When the energy state “X@@” at the first time t0 are transformed to the state “@@X” at the second time t1, it appears that the label “@@” are shifted to left position. It is therefore a leftward shift in the sensor pixel group 121 determined, as the arrow shows in the diagram.

Further, in the sensor pixel group 122, the energy state of the adjacent sensor pixels is “@@X” showing the energy change occurred at the first time t0; and the energy state is “X@@” at the second time t1. The transformation is made between the times t0 and t1, and it shows the label “@@” is rightward shifted. The method of light tracing may therefore adopt this scheme to determine the overall movement within a period of time.

It is noted that since the present disclosure uses the sensing array for determining the moving direction. The tiny error does not affect the overall results of the judgment. If the tracing method is applied to the computer optical mouse, some slowly varying reference values does not affect the overall judgment because of the moving frequency of the user operating the mouse is far lower than the processing speed of the control circuit.

To sum up, the present disclosure relates to the electronic device installed with a sensing array device. The sensing array device is integrated into a semiconductor package. Thereby the sensing array device can effectively suppress the intrinsic noise, and propose the compensating mechanism which can dynamic adjust intensity or brightness of the light source. Adjustment may be made within the exposure time. the design of sensor array is adapted to more sensing surfaces. In particular, the electronic device needs not to install any additional optical lens or particular image sensor, such as CMOS image sensor (CIS). The device needs not to install any optical element. The device can immediately receive the reflective lights by the sensing cells, and calculate the energy changes before and after a period of time. The detection for the operating behavior of the device is used for controlling the cursor.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An electronic device having an optical indexing module, the electronic device comprising:
a shell, installed with the optical indexing module, the optical indexing module comprising:
a control unit, adapted for integrating circuit signals within the optical indexing module for generating a moving signal;
a light-emitting unit, connected to the control unit, providing a light source to emit lights via a light passage of the shell;
a light sensing unit, connected to the control unit, comprising a plurality of sensing cells, wherein the sensing cells are arranged in a sensing array, and the sensing array is adapted for receiving lights via the light passage; and
a connection interface, connected to the control unit, adapted for connecting a computer system, wherein the electronic device transmits the moving signal to the computer system via the connection interface;
wherein, the electronic device obtains an energy difference of a spatial interference formed around a sampling time after computing the energy received by each of sensing cells within the sampling time, and the energy difference is referred to generate the moving signal for determining a moving direction.

2. The electronic device having the optical indexing module according to claim 1, wherein the computer system is a computer device, the shell is a case of the computer device, the optical indexing module is disposed within the shell, and the light passage is a opening disposed on the surface of the shell.

3. The electronic device having the optical indexing module according to claim 2, wherein the opening is formed on top of a touch-control pad of the computer device.

4. The electronic device having the optical indexing module according to claim 2, wherein the opening is formed aside of a touch-control pad of the computer device.

5. The electronic device having the optical indexing module according to claim 1, wherein the computer system is a computer device, the shell is a case of an input device having an independent power management circuit, the optical indexing module is disposed within the shell, and the opening is formed on the surface of the shell.

6. The electronic device having the optical indexing module according to claim 5, wherein the input device is connected to the computer device over a wired or wireless connection.

7. The electronic device having the optical indexing module according to claim 2, further comprising:
a control interface unit, connected to the control unit, and connected to a control interface on the shell, wherein the control interface unit is adapted for generating a control signal to operate the control interface.

8. The electronic device having the optical indexing module according to claim 7, wherein the control interface is as a keypad on the shell or a touch-control pad.

9. The electronic device having the optical indexing module according to claim 5, the electronic device comprising:
a control interface unit, connected to the control unit, and connected to a control interface on the shell, wherein the control interface unit is adapted for generating a control signal to operate the control interface.

10. The electronic device having the optical indexing module according to claim 9, wherein the control interface is a keypad on the shell or a touch-control pad.

11. The electronic device having the optical indexing module according to claim 1, wherein the sensing cells arranged in the sensing array include a plurality of dummy sensing cells, and the sensing array is adapted for receiving the lights-reflected from a surface via the light passage.

12. The electronic device having the optical indexing module according to claim 11, wherein the sensor cells are disposed with a fixed distance and with average relative position there-between.

13. The electronic device having the optical indexing module according to claim 12, wherein the dummy sensing cells are disposed around the sensing array.

14. The electronic device having the optical indexing module according to claim 11, wherein light sensing unit comprises:
a plurality of comparators, wherein each of the comparators is correspondingly connected to one sensing cell, each of the comparators-is adapted for comparing two energy signals, in which one of the energy signals is generated by the sensing cell, and the other one of the energy signals is a statistical average value of the effective energy obtained by the sensing cells, whereby computing the energy difference of the spatial interference formed around the sampling time.

15. The electronic device having the optical indexing module according to claim 1, wherein the light passage is a opening on the shell of the electronic device, and the opening is disposed at a location opposite to the light source; the opening is in order to facilitate the light emitted out of the electronic device having the optical indexing module, and the multiple sensing cells arranged in the array are in order to receive the reflected light via the opening.

16. The electronic device having the optical indexing module according to claim 15, wherein the light source is a laser with well spatial coherence.
